(19) United States
(12) Patent Application Publication
(10) Pub. No.: US 2016/0041834 A1
(43) Pub. Date: Feb. 11, 2016

(54) Virtual Desktop Client, Control Chip for Virtual Desktop Client and Method for Controlling Server Device

(71) Applicant: MStar Semiconductor, Inc., Hsinchu Hsien (TW)

(72) Inventors: Long-Yi Lee, Hsinchu Hsien (TW); Meng-Che Tsai, Taipei City (TW)

(21) Appl. No.: 14/819,538

(22) Filed: Aug. 6, 2015

(30) Foreign Application Priority Data
Aug. 8, 2014 (TW) 103127276

(51) Int. Cl. G06F 9/455

(52) U.S. Cl. CPC G06F 9/455

(57) ABSTRACT

A virtual desktop client for controlling a server device and displaying an operation image corresponding to the server device on a display device is provided. The virtual desktop client includes: a network control module, configured to receive a remote image from the server device; an input driving module, configured to drive an input device connected to the virtual desktop client, and to generate input information by the input device; and a control chip, configured to draw a pattern on the remote image according to the input information to obtain a client-end image, and to display the operation image on the display device according to the client-end image. The control chip further generates control information according to the input information that is associated with a position of the pattern, and transmits the control information to the server device through the network control module.

This application claims the benefit of Taiwan application Serial No. 103127276, filed Aug. 8, 2014, the subject matter of which is incorporated herein by reference.

### BACKGROUND OF THE INVENTION

1. Field of the Invention

The invention relates in general to a virtual desktop client, a control chip for a virtual desktop client and a method for controlling a server device, and more particularly to a virtual desktop client, a control chip for a virtual desktop client and a method for controlling a server device capable of an immediate reaction without delay in response to a user operation.

2. Description of the Related Art

In common applications of remote desktops, virtual desktops or cloud virtual desktop infrastructures (VDI), a server at a remote end transmits a remote image (i.e., an operation image or desktop) to a local end (or referred to as a client device). A user operates an input device such as a mouse or a keyboard at a client end to give an instruction to the server through the network. After processing data or executing a program according to the user operation, the server transmits an updated remote image to the client device to provide the user with the corresponding operation result.

Compared to a server, hardware of a client device is extremely simple in order to reduce the cost of the client device and to fully utilize resources of the server. For example, Thin Client or Zero Client is a client device having basic input and display functions. During an operation, the client end transmits coordinates of a mouse to the server, which then draws a cursor of the mouse on the remote image and transmits the remote image containing the cursor to the client end. With such back-and-forth transmission through the network, the position of the cursor may fail to be immediately updated as a result of the transmission delay. Thus, the user may easily sense the latency in the mouse cursor, leading to unfavorable user experiences.

### SUMMARY OF THE INVENTION

The invention is directed to a virtual desktop client, a control chip for a virtual desktop client and a method for controlling a server device to reduce the latency in a mouse cursor during a remote-end operation.

The present invention discloses a virtual desktop client for controlling a server device and for displaying an operation image corresponding to the server device on a display device. The virtual desktop client includes: a network control module, configured to receive a remote image from the server device; an input driving module, configured to drive an input device connected to the virtual desktop client, and to generate input information by the input device; and a control chip, configured to draw a pattern on the remote image according to the input information to obtain a client-end image, and to display the operation image on the display device according to the client-end image. The control chip further generates control information according to the input information that is associated with a position of the pattern, and transmits the control information to the server device through the network control module.

The present invention further discloses a method for controlling a server device. The method includes: receiving a remote image from the server device through a network; obtaining input information from an input device; drawing a pattern on the remote image according to the input information to obtain a client-end image; generating control information according to the input information; and transmitting the control information to the server device. The control information is associated with a position of the pattern.

The present invention further discloses a control chip for a virtual desktop client. The control chip is for controlling a server device and for displaying an operation image corresponding to the server device on a display device. The control chip includes: a drawing unit, configured to draw a pattern on the remote image according to input information to obtain a client-end image; an image processing unit, configured to adjust the client-end image according to a resolution of the display device to obtain the operation image; and a calculation unit, configured to generate control information associated with a position of the pattern according to the input information, and to transmit the control information to the server device.

The virtual desktop client, the control chip for a virtual desktop client and the method for controlling a server device of the present invention are capable of reducing the latency in a mouse cursor. Compared to the prior art, the present invention allows a user to smoothly use the mouse during a remote operation and thus enhances user experiences.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of a virtual desktop client according to an embodiment of the present invention;

FIG. 2 is a schematic diagram of a control chip for a virtual desktop client according to an embodiment of the present invention;

FIG. 3 is a diagram of software architecture of a control chip for a virtual desktop client according to an embodiment of the present invention; and

FIG. 4 is a flowchart of a method for controlling a server device according to an embodiment of the present invention.

### DETAILED DESCRIPTION OF THE INVENTION

Technical terms of the application are based on the general definition in the technical field of the application. If the application describes or explains one or some terms, definitions of the terms are based on the description or explanation of the application.

The present invention discloses a virtual desktop client, a control chip for a virtual desktop client and a method for controlling a server device capable of reducing the latency in a mouse cursor. In possible implementation, one skilled person in the art may choose equivalent devices or steps to implement the disclosure based on the disclosure of the application. That is, the implementation of the disclosure is not limited in the embodiments described in the disclosure. Further, a part of the elements included in the virtual desktop client and the control chip for a virtual desktop client of the disclosure may be individually known. Without affecting the full disclosure and possible implementation of the virtual desktop client and the control chip for a virtual desktop client, the known details are omitted. Further, the method for controlling a virtual desktop client of the present invention may be implemented by the virtual desktop client and the control chip for a virtual desktop client of the disclosure or an equivalent device. Without affecting the full disclosure and possible implementation of the method, the description of the method focuses on the steps instead of hardware.

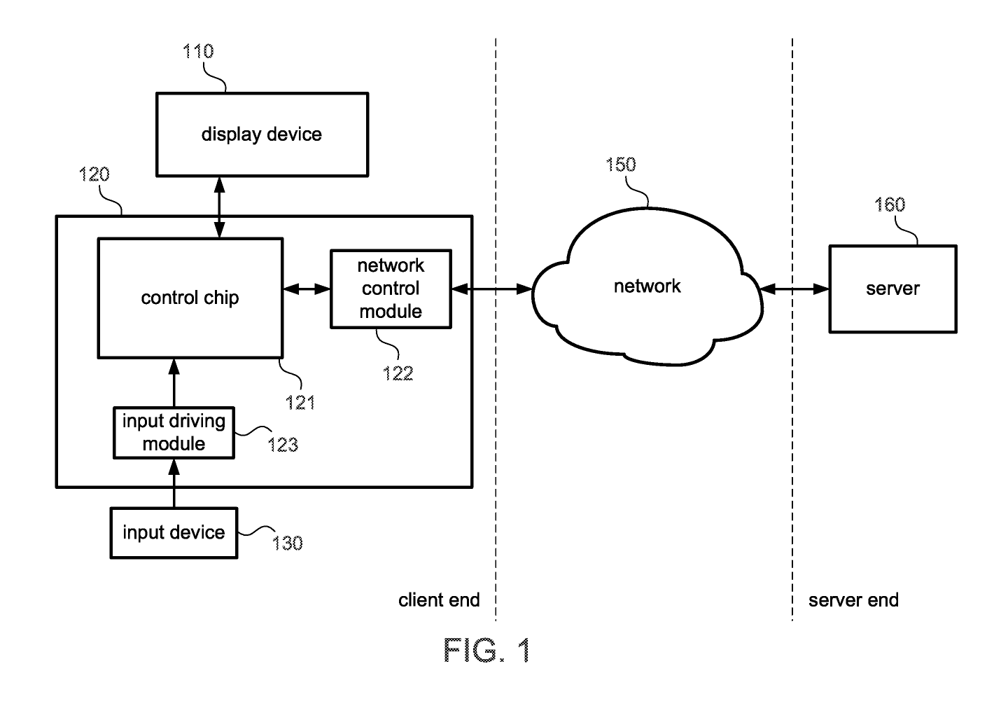

FIG. 1 shows a schematic diagram of a virtual desktop client according to an embodiment of the present invention. The client end includes a display device 110, a client host 120 and an input device 130. The client host 120 includes a control chip 121, a network control module 122 and an input driving module 123. The client host 120 connects to a server 160 of a server end through a network 150. For example, the network 150 may be the Internet or a local area network (LAN). For example, the network 150 is the Internet when the client host 120 located in a different domain from the server 160 connects to the server 160 through a firewall, and is a LAN when the client host 120 and the server 160, located in a same domain, can directly connect to each other without the separation of a firewall in between. During an operation, the server 160 transmits its remote image (i.e., an operation image or desktop of the server 160) to the network control module 122 through the network 150. The remote image does not include any user operation cursor. Assuming the user uses a mouse as an input device, the remote image excludes the mouse cursor. The network control module 122 transmits the remote image to the control chip 121 coupled to the network control module 122. On the other hand, the client host 120 is connected to the input device 130, e.g., an input device such as a mouse, a touch pad or a keyboard. The input driving module 123 is loaded with a driver for the input device 130, and is capable of generating displacement information according to an operation of the input device 130. The control chip 121, coupled to the input driving module 123, calculates the displacement information and an original coordinate information of the cursor to obtain updated coordinate information. The control chip 121 then draws the cursor on a remote image received from the server 160 according to the updated coordinate information to form a client-end image, and displays the client-end image on the display device 110. As the cursor is drawn at the client end, operation conditions of the input device 130 can be immediately reflected without latency.

When the control chip 121 displays the client-end image, the client-end image is adjusted according to the resolution of the display device 110. In addition to the coordinate information of the cursor, the control chip 121 further transmits the resolution of the display device 110 to the server 160 through the network control module 122. The server 160 calculates corresponding coordinates of the cursor on the remote image according to the resolution of the display device 110, the coordinate information of the cursor and its display device (not shown). Further, the control chip 121 further transmits operation information of the input device 130 obtained by the input driving module 123, e.g., information of selecting, clicking or moving, to the server 160 through the network control module 122. The server 160 performs a corresponding process or operation according to the corresponding coordinates or operation information of the cursor on the remote image of the server, displays an operation result on the remote image, and transmits the updated remote image to the client host 120. The control chip 121 may updates the cursor coordinate information at an interval by executing a thread, and the server 160 obtains the coordinate information from the client host 120 through a callback function. However, the control chip 121 may also initiatively send the coordinate information to the server 160. The operation information of the input device 130 may be transmitted jointly with the coordinate information, or be independently transmitted. The resolution of the display device 110 may be transmitted to the server 160 when the client host 120 is booted, or may be transmitted each time with the coordinate information.

It should be noted that, the display device 110 may be integrated in form of a display module in the client host 120. As such, the client host 120 is equivalently an all-in-one computer having a screen that can be directly connected to the input device 130 and used. The server 160 at the server end may be connected to a display device and an input device. When the server end operates locally, the cursor of the input device of the server end is drawn on the remote image. However, when the server end is connected to the client end, before transmitting the remote image, in order to have the client end see only the cursor drawn by/at the client end and to prevent confusion resulted by two cursors, the cursor of the input device of the server end previously drawn needs to be eliminated.

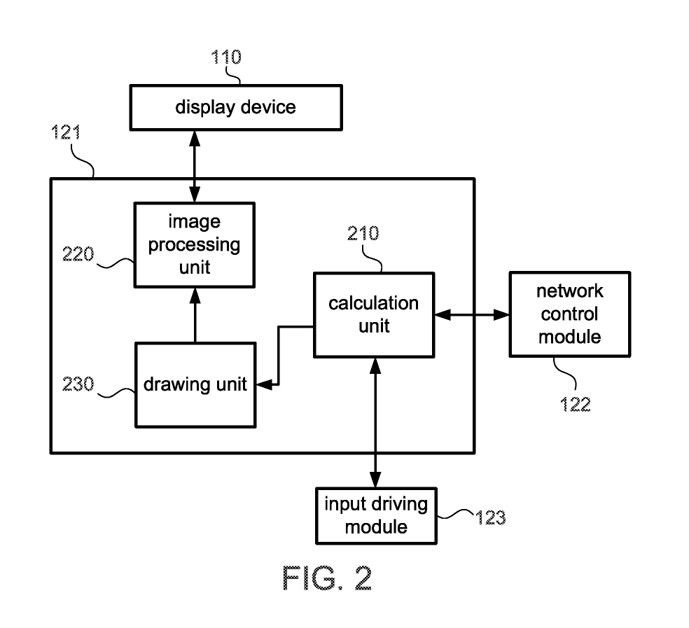

FIG. 2 shows a schematic diagram of a control chip for a virtual client desktop according to an embodiment of the present invention. The control chip 121 includes a calculation unit 210, an image processing unit 220 and a drawing unit 230. The calculation unit 210 calculates the coordinate information of the cursor according to the displacement information that the input driving module 123 provides, receives the remote image of the server end through the network control module 122, and transmits the coordinate information and the remote image to the drawing unit 230. The drawing unit 230, e.g., a graphic engine, coupled to the calculation unit 210, draws the cursor on the remote image according to the remote image and the coordinate information that the calculation unit 210 transmits to generate the client-end image. The image processing unit 220, coupled to the drawing unit 230 and the display device 110, adjusts the client-end image that the drawing unit 230 generates according to the resolution of the display device 110, e.g., scaling the client-end image, to match the resolution of the display device, and outputs the adjusted client-end to the display device 110. Before transmitting the remote image to the drawing unit 230, the calculation 210 may further decode the remote image. For example, assuming the remote image is encoded by the H.264 format, the calculation unit 210 decodes the remote image by a corresponding decoding method and transmits the decoded remote image to the drawing unit 230.

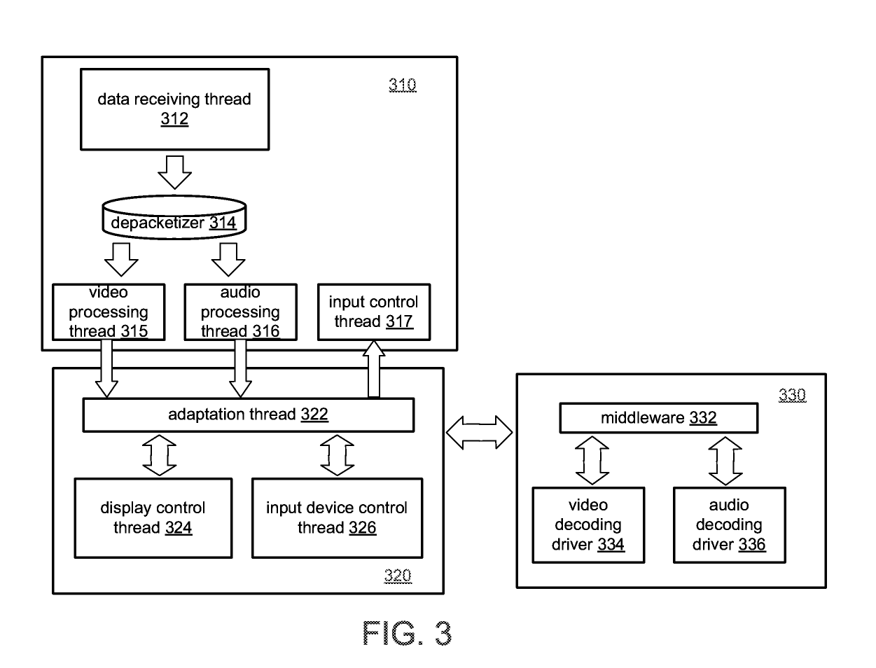

FIG. 3 shows a diagram of software architecture of a control chip for a virtual desktop client according to an embodiment of the present invention. The software architecture includes three main parts—a server communication module 310, a client control module 320 and a hardware driving module 330. The server communication module 310 includes multiple threads. A data receiving thread 312 receives data from the server end, including video/audio data of the remote image and sound effects. A depacketizer 314 depacketizes the data loaded with the video/audio data to obtain payload of video and forwards the payload to a video processing thread 315, which then accordingly obtains video/audio data. Payload of audio is processed by an audio processing thread 316 to obtain audio data. An input control thread 317 obtains the coordinate information of the input device from the client control module 320 for further use of the server end.

An adaptation layer 322 of the client control module 320 transmits and converts data between the server communication module 310 and the client control module 320. A display control thread 324 is in charge of controlling the displayed image, e.g., drawing the cursor on the remote image and scaling the client-end image according to the resolution of the display device. An input device control thread 326 updates the coordinate information of the cursor at a predetermined time interval. A middleware 322 of the hardware driving module 330 transmits and converts multimedia video/audio data. For video/audio data that the client control module 320 obtains from the server communication server 310, a video decoding driver 334 and an audio decoding driver 336 control hardware for decoding. For example, the video decoding driver 334 controls the hardware decoding for the H.264 format, and the audio decoding driver 336 controls the hardware decoding for the advanced audio decoding (AAC) format.

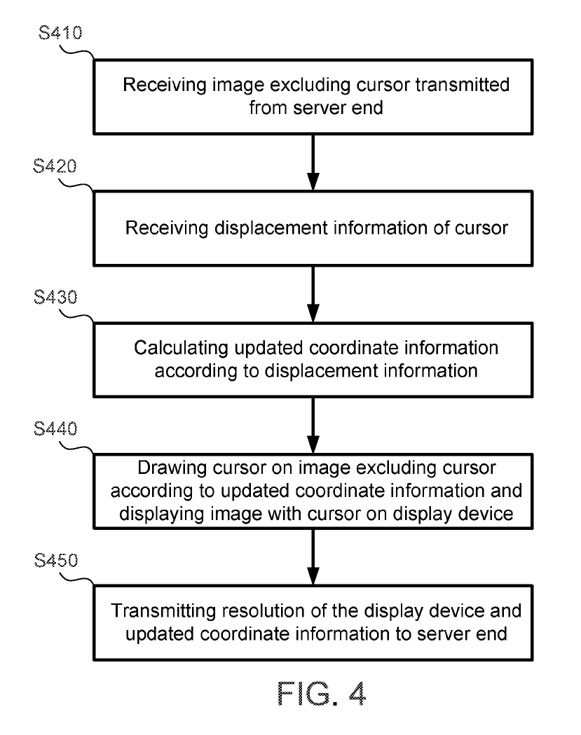

FIG. 4 shows a flowchart of a method for controlling a server device according to an embodiment of the present invention. In addition to the foregoing virtual desktop client and the control chip for a virtual desktop client, the present invention further correspondingly discloses a method for controlling a server device capable of preventing cursor latency. The method may be performed by the client host 120, the control chip 121, or an equivalent device. As shown in FIG. 4, the method according to an embodiment of the present invention includes following steps.

In step S410, an image excluding the cursor transmitted by the server end is received. The server end transmits the remote image, which excludes a cursor, to the client end through a network. During the transmission, a predetermined image format, e.g., H.264, is used for encoding to reduce the amount of the transmission. After receiving the encoded image, a corresponding decoding process is performed for decoding to obtain the image excluding the cursor.

In step S420, displacement information of the cursor is received. The client end usually controls the cursor using an input device such as a mouse, a keyboard or a touch pad. Displacement information is generated when the input device is operated. This step includes obtaining the displacement information from the driver of the input device.

In step S430, updated coordinate information is calculated according to the displacement information. This step uses a current coordinate position of the cursor, and refers to the displacement information obtained in step S420 to calculate the latest position of the cursor, i.e., to update the coordinate information of the cursor. In this step, a thread may be executed once at a predetermined interval (e.g., several tenth to several thousandth of a second) to obtain the latest coordinate information.

In step S440, the cursor is drawn according to the updated coordinate information to the image excluding the cursor, and the drawn image is displayed on a display device. According to the coordinate information obtained in step S430, the cursor is drawn on the remote image excluding the cursor to form a client-end image. Further, according to the resolution of the display device, the client-end image is processed, e.g., processed by scaling, and the processed client-end image is displayed on the display device.

In step S450, the resolution of the display device and the updated coordinate information are transmitted to the server end. The resolution of the display device may be transmitted jointly with the coordinate information, or may be transmitted independently, e.g., when the host at the client end is booted. The client host may provide a callback function to be called by the server end. When the server end needs the latest coordinate information, the callback function is called to cause the client host to transmit the latest coordinate information to the server end. The client end may also initiatively transmit the latest coordinate information to the server end.

Given the coordinate information and the resolution of the display device at the client end are received, the remote end may refer to the resolution of its remote image to calculate the corresponding position of the cursor at the client-end at the server end and to perform a corresponding operation. Further, the input device at the client end may also generate operation information, e.g., operations including selecting, clicking and moving. The operation information and the coordinate information may be transmitted jointly to the server end, or may be separately transmitted. According to the resolution of the display device, the coordinate information and the operation information at the client end, the client end may perform a corresponding operation and transmit the updated remote image back to the client end.

One person skilled in the art can understand implementation details and variations of the method in FIG. 4 from the disclosure of the device and software architecture in FIG. 1 to FIG. 3. Without affecting full disclosure and implementation of the method of the present invention, repetitive details are omitted herein. It should be noted that, the shapes, sizes, ratios and sequences of the steps in the drawings are examples for explaining the present invention to one person skilled in the art, not limiting the present invention. In possible implementation, one skilled person in the art would selectively implement part or all technical features of any embodiment of the application or selectively combine part or all technical features of the embodiments of the application based on the disclosure of the present invention to enhance the implementation flexibility of the present invention.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A virtual desktop client, for controlling a server device and displaying an operation image corresponding to the server device on a display device, the virtual desktop client comprising:
a network control module, configured to receive a remote image from the server device;
an input driving module, configured to drive an input device connected to the virtual desktop client, and to generate input information by the input device; and
a control chip, configured to draw a pattern on the remote image according to the input information to obtain a client-end image, and to display the operation image on the display device according to the client-end image;
wherein, the control chip further generates control information according to the input information, the control information is associated with a position of the pattern, and the control chip further transmits the control information to the server device through the network control module.

2. The virtual desktop client according to claim 1, wherein the remote image excludes a cursor.

3. The virtual desktop client according to claim 1, wherein the control information comprises one of displacement information and coordinate information.

4. The virtual desktop client according to claim 1, wherein the input information comprises displacement information, and the control chip comprises:
a calculation unit, configured to generate coordinate information according to the displacement information;
a drawing unit, configured to draw the pattern on the remote image according to the coordinate information to obtain the client-end image; and
an image processing unit, configured to adjust the client-end image according to a resolution of the display device to generate the operation image.

5. The virtual desktop client according to claim 1, wherein the control chip further transmits a resolution of the display device to the server device through the network control module.

6. The virtual desktop client according to claim 1, wherein the input driving module further obtains operation information from the input device, and the control chip transmits the operation information to the server device through the network control module.

7. A method for controlling a server device, comprising:
receiving a remote image from the server device through a network;
obtaining input information from an input device;
drawing a pattern on the remote image according to the input information to obtain a client-end image;
displaying an operation image corresponding to the server device at a virtual desktop client according to the client-end image;
generating control information according to the input information; and
transmitting the control information to the server device;
wherein, the control information is associated with a position of the pattern.

8. The method according to claim 7, wherein the remote image excludes a cursor.

9. The method according to claim 7, wherein the control information comprises one of displacement information and coordinate information.

10. The method according to claim 7, wherein the step of displaying the operation image corresponding to the server device at the virtual desktop client according to the client-end image comprises:
adjusting the client-end image according to a resolution of the display device to generate the operation image; and
controlling the display device to display the operation image.

11. The method according to claim 7, wherein the input information comprises displacement information, and the step of drawing the pattern on the remote image according to the input information to obtain the client-end image comprises:
generating coordinate information according to the displacement information; and
drawing the pattern on the remote image according to the coordinate information to obtain the client-end image.

12. The method according to claim 7, further comprising:
obtaining operation information from the input device; and
transmitting the operation information to the server device to control the server device.

13. The method according to claim 7, further comprising:
transmitting a resolution of the display device to the server device.

14. The method according to claim 13, wherein the server device comprises a remote display device, the method further comprising:
controlling the server device to convert the displacement information to remote displacement information or to convert the coordinate information to remote coordinate information according to the resolution of the display device and a resolution of the remote display device; and
controlling the server device to operate according to one of the remote displacement information and the remote coordinate information.

15. A control chip for a virtual desktop client, for receiving a remote image from a server device and displaying an operation image on a display device, the control chip comprising:
a drawing unit, configured to draw a pattern on the remote image according to the coordinate information to obtain a client-end image;
an image processing unit, configured to adjust the client-end image according to a resolution of the display device to generate the operation image; and
a calculation unit, configured to generate control information associated with a position of the pattern according to the input information, and to transmit the control information to the server device.

16. The control chip according to claim 15, wherein the control information comprises one of displacement information and coordinate information.

17. The control chip according to claim 15, wherein the input information comprises displacement information, and the calculation unit further generates coordinate information according to the displacement information.

18. The control chip according to claim 15, wherein the remote image excludes a cursor.

19. The control chip according to claim 15, wherein the calculation unit transmits a resolution of the display device to the server device.

20. The control chip according to claim 15, wherein the calculation unit further obtains operation information and transmits the operation information to the server device to control the server device.
